(19) United States
(12) Patent Application Publication
(10) Pub. No.: US 2026/0307945 A1
(43) Pub. Date: Oct. 8, 2026

(54) SPREADER BEAM, CRANE AND VESSEL

(71) Applicants: Temporary Works Design Engineering B.V., Rotterdam (NL); Barge Master IP B.V., Rotterdam (NL)

(72) Inventors: Johannes Barend VAN WUIJCKHUIJSE, Rotterdam (NL); Berend Jan HOOGENDIJK, Rotterdam (NL)

(73) Assignees: Temporary Works Design Engineering B.V., Rotterdam (NL); Barge Master IP B.V., Rotterdam (NL)

(21) Appl. No.: 19/164,303

(22) PCT Filed: Mar. 13, 2024
(86) PCT No.: PCT/EP2024/056665

§ 371 Date: Sep. 11, 2025

(30) Foreign Application Priority Data
Mar. 13, 2023 (NL) 2034330

(51) Int. Cl. B66C 1/16; B66C 1/10; B66C 13/06; B66C 23/00

(52) U.S. Cl. CPC B66C 1/16; B66C 13/063; B66C 23/54; B66C 1/108

(57) ABSTRACT

The invention relates to a spreader beam for distributing a lifting force of a hoisting crane over a load to be lifted. The spreader beam comprises at the first end, a first lug for attachment to a first elongate hoisting assembly; at the second end, a second lug for attachment to a second elongate hoisting assembly; a first mechanical linkage arranged at the first end of the spreader beam and having a first actuator; and a second mechanical linkage arranged at the second end of the spreader beam and having a second actuator. The first and second lugs are mounted to the first respectively second linkage. The first and second actuators are configured to act on the first respectively second linkage for moving the first respectively second lug relative to the beam. The first and second adjustment mechanisms are configured to be operative independently from each other.

### BACKGROUND OF THE INVENTION

Spreader beams and lifting beams are pieces of equipment used to lift or move large and heavy objects or large fragile loads. They are used to stabilise and support the load during an overhead lift.

A spreader beam—also called spreader bar—is a beam where the load being lifted mainly puts a compressive stress in the beam. At the upperside of the beam a triangle is defined by the beam and the two legs of an upper sling. Two attachment points on the upperside of the beam attach to the two triangle legs of a chain sling or synthetic sling or steel wire sling at a particular angle designed to ensure compression of the spreader beam. This evenly distributes the weight of the load across the two slings, which then connect to a crane, hoist, or other lifting machine. Two lugs on the bottom (one at each end) of the beam connect to a sling or hook which are then connected to the load. One or more tugger lines (also called tag lines) may be used to keep the load under control and reduce the possibility of surging swaying, and yawing.

A lifting beam, is a beam where the load being lifted puts a bending stress in the beam. A lifting beam has a simple design consisting of a beam with a single attachment point centred on the upperside of the beam for connecting to a crane, hoist, or other lifting machine. Some lifting beams may have two bails in order to engage two crane or hoist hooks. There are typically two or more evenly-spaced lifting lugs on the underside of the beam that attach to and support the load via hook or sling.

In offshore it is known to equip lifting beams with a compensation which compensates for movement of the crane relative to the vessel to be loaded or unloaded. Examples of such lifting beams can be found in U.S. Pat. No. 3,837,697 of 1974 and the more recent WO 2021/228339. It is noted that in both documents the beam is called a spreader bar (/beam), but it is actually a lifting beam because of the single attachment point at the upperside of the beam. These lifting beams have in common that the compensation mechanism is based on cables traversing between pulleys having one pulley movable by means of an actuator. Heavy loads require a large number of back and forth turns of the cable between the pulleys, which in turn results in large friction losses which make the compensation mechanism less efficient and accurate.

### SUMMARY OF THE INVENTION

It is an object of the invention to provide a beam to be used in lifting objects by a crane, which beam is provided with an alternative adjustment mechanism allowing compensation in offshore use. A further object of the invention is to provide such a beam having an adjustment mechanism for offshore use, which is capable of dealing with very heavy and large loads. Another further object of the invention is to provide such a beam with adjustment mechanism for offshore use, which spreader beam overcomes one or more of the problems associated to prior art spreader beams.

C1: One or more of the above objects are according to a first aspect of the invention achieved by providing a spreader beam for distributing a lifting force of a hoisting crane over
a load to be lifted,
the spreader beam extending from a first end to a second end,
wherein the spreader beam comprises:
   at the first end, a first lug for attachment to a first elongate hoisting assembly-such as a cable, a chain, a sling, or a multiple of cables, chains or slings-,
   at the second end, a second lug for attachment to a second elongate hoisting assembly such as a cable, a chain, a sling, or a multiple of cables, chains or slings-,
   a first adjustment mechanism configured for adjusting the position of the first lug relative to the spreader beam, and
   a second adjustment mechanism configured for adjusting the position of the second lug relative to the spreader beam;
wherein the first adjustment mechanism comprises:
   a first mechanical linkage arranged at the first end of the spreader beam, and
   a first actuator system,
the first lug being mounted to the first mechanical linkage, the first mechanical linkage being mounted to the spreader beam by a (first) hinged joint, and the first actuator system being configured to act on the first mechanical linkage for moving the first lug relative to the spreader beam;
wherein the second adjustment mechanism comprises:
   a second mechanical linkage arranged at the second end of the spreader beam, and
   a second actuator system,
the second lug being mounted to the second mechanical linkage, the second mechanical linkage being mounted to the spreader beam by a (second) hinged joint, and the second actuator system being configured to act on the second mechanical linkage for moving the second lug relative to the spreader beam; and
wherein the first and second adjustment mechanism are configured to be operative independently from each other.

In this application a lug is an attachment point for coupling an elongate hoisting assembly—such as a cable, chain or sling—to the spreader beam.

The spreader beam according to the invention thus has two adjustment mechanisms which are operative independent from each other, i.e. operating one of the adjustment mechanisms basically does not influence operation of the other adjustment mechanism, although both adjustment mechanisms may be operated simultaneously and in cooperation.

Each of the adjustment mechanisms comprises, and may consist of, a mechanical linkage and further comprises its own actuator system configured to act on the respective mechanical linkage for moving the lug associated to the linkage relative to the spreader beam. Each of the actuator systems may be a linear actuator system.

Each of the adjustment mechanisms may be an actively controlled adjustment mechanism for active compensation and/or a passive adjustment mechanism for passive compensation. Passive compensation is in general by means of a spring or spring action. In case of active compensation a controller will be involved, which controller generates a control signal to control movement of the actuator.

Passive and active compensation may according to the invention also be combined. In this case each actuator system will comprise a passive actuator dealing with the weight of the load and an active actuator for the controlled adjustments. The passive and active actuator will be arranged in parallel. In such a combination, the forces required for the active control are considerably reduced, because the passive actuator already deals with the weight of the load.

Referring to wikipedia—https://en.wikipedia.org/wiki/linkage (mechanical)—a mechanical linkage is an assembly of one or more rigid links—also called link bars—, which are connected to a sub-structure and—in case of more than one link-to each other by hinged joints, to manage forces and movement.

The mechanical linkage allows to deal with quite heavy loads without being hindered to much by friction losses.

The spreader beam according to the invention allows offshore handling of very heavy objects, especially elongate objects like monopiles, having a weight of more than 500 tons, such as more than 1000 tons, more than 1500 tons, or even more than 2000 tons.

Using a spreader beam with two attachment points for the two legs of an upper sling, allows more accurate manipulation of the beam with respect to pitch and/or roll compensation. Due to the triangular rigging, the compensation systems can apply a moment on the lifted load much better than lifting beams which cannot create a moment through the single attachment point for attachment to the crane.

According to a first example, the first and second mechanical linkage may each consist of a single (rigid) link bar, one end of which is pivotally attached—by means of the hinged joint-to the spreader beam, the actuator system engaging the other end of the link bar and the spreader beam, and the lug being provided on the connecting rod between the one end and the other end thereof, so that the link bar serves as a lever arm. According to a second example, the first and second mechanical linkage may each consist of two link bars, having their first ends hingedly connected to each other, the other end of the first link bar being pivotally attached—by means of the hinged joint—to the spreader beam, the actuator system engaging the other end of the second link bar and the spreader beam, and the lug being provided on the first link bar, or on the second link bar, or on the hinged connection between the two link bars.

C2: According to a further embodiment of the first aspect of the invention, the first and second mechanical linkage each comprise four link bars connected by hinges defining a quadrangular linkage, wherein a first one of the hinges defines the first respectively second hinged joint mounting the respective mechanical linkage to the spreader beam, wherein the lug associated to the respective mechanical linkage is provided at a second one of the hinges opposite the first hinge, and wherein the actuator system associated to the respective linkage is arranged (mounted) on the linkage so as to move two opposite pivot points of the linkage relative to each other. Using such a quadrangular linkage provides a linkage, in which movement of the actuator system is efficiently transferred into displacement of the lug, and in which leverage is still available.

C3: According to a further embodiment of the ‘quadrangular linkage’ embodiment, the quadrangular linkage may according to the first aspect of the invention be a parallelogram construction of the four said link bars. This construction allows the lug carried by the linkage to be displaced along a straight line, which is very efficient from a mechanical perspective.

C4: According to another further embodiment, separate from or in addition to previous further embodiments, the first and second actuator system may, according to the first aspect of the invention, each have a principal direction of operation, which principal direction is transverse to the elongate hoisting assembly (to be) attached to the first respectively second lug. Designing the spreader beam with the principal direction of the first and second actuator mechanism transverse to the elongate hoisting assembly, allows an optimal force introduction throughout its operating range.

C5: According to another further embodiment, separate from or in addition to previous further embodiments, the first and second actuator system may, according to the first aspect of the invention, each comprise a hydraulic actuator system. Hydraulic actuator systems are very efficient in applying forces on the order of thousand tons or even thousands of tons.

C6 and 8: According to a further embodiment of the ‘hydraulic actuator system’ embodiment, the spreader beam may, according to the first aspect of the invention, further comprise an accumulator system with a pressurized gas and configured to be connectable with the first and second hydraulic actuator systems. By configuring the accumulator system to act as a spring for each of the hydraulic actuator systems, this accumulator system with pressurized gas may efficiently be used to provide the hydraulic actuator systems with a spring action. In addition or alternatively, such an accumulator system with pressurized gas may efficiently be used to provide a ‘quick lift movement’, see further below.

C7: According to a further embodiment of the ‘accumulator system’ embodiment, the accumulator system may, according to the first aspect of the invention, comprises a first accumulator configured to be connectable with the first hydraulic actuator system, and a second accumulator configured to be connectable with the second hydraulic actuator system, the first and second accumulator being configured to be operative independently from each other. This may be helpful in providing each of the actuator systems with a spring action independent of the spring action of the other actuator system. According to a first example of this embodiment, the accumulator system may, according to the invention, comprise three accumulators, a first one for providing spring action to the first actuator system, a second one for providing spring action to the second actuator system, and the third one for providing both actuator systems with the ‘quick lift’ functionality. According to a second example of this embodiment, the accumulator system may, according to the invention, comprise four accumulators, a first one for providing spring action to the first actuator system, a second one for providing spring action to the second actuator system, a third one for providing the first actuator system with the ‘quick lift’ functionality, and the fourth one for providing the second actuator system with the ‘quick lift’functionality.

C9: According to another further embodiment, separate from or in addition to previous further embodiments, the spreader beam may further comprise a controller, and the controller, the first actuator system, and the second actuator system may be configured to extend the first and second actuator system, within a timeframe of about half the wave period of the water, over a distance of at least 2 to 3 decimeters, such as over a distance of at least 2 to 7 decimeters. The distance may for example be in the range of 0.5 to 1 meter. This ‘quick lift movement’ functionality allows the load to be hoisted to be quickly moved upwards to get out of reach of the vessel or platform undergoing heave, roll and/or pitch movements caused by water movement.

C10: In case of the ‘accumulator system’ embodiments, the ‘quick lift movement’ functionality may be achieved by providing the valve between the accumulator system and each of the hydraulic actuator systems, and by configuring the accumulator system, the controller, and the valve to extend the hydraulic actuator systems, within a timeframe of about halve the wave period of the water, over a distance of at least 2 to 3 decimeters, such as over a distance of at least 2 to 7 decimeters or over a distance in the range of 0.5 to 1 meter, once the valve is opened by the controller. In this embodiment, the first actuator system and the second actuator system may each comprise a passive actuator to carry the weight of the load and an actively controlled actuator for active control with relatively low control forces.

C11-12: According to another further embodiment, separate from or in addition to previous further embodiments, the first lug and the second lug may, according to the first aspect of the invention, be configured for attachment to a first respectively second hoisting assembly extending between the spreader beam and the load to be lifted. In practice this will boil down to the first lug and the second lug being provided at the underside of the spreader beam or at the right and left side of the spreader beam. Alternatively, the first lug and the second lug may, according to the first aspect of the invention, be configured for attachment to a first respectively second hoisting assembly extending between the spreader beam and the hoisting crane. In practice this will boil down to the first lug and the second lug being provided at the upperside of the spreader beam.

C13-14: According to another further embodiment, separate from or in addition to previous further embodiments, the spreader beam may, according to the first aspect of the invention, be configured to be carried by a hoisting triangle, also called triangular rigging, having an upper corner for attachment to a crane hook, a first lower corner for attachment to the first end of the spreader beam, and a second lower corner for attachment to the second end of the spreader beam so that a lifting force exerted by the crane hook introduces mainly compressive forces in the spreader beam. Such a hoisting triangle/triangular rigging may be made from two hoisting line assemblies, a crane lug defining a top corner of the triangle, and two upper beam lugs mounted on the beam and each defining a lower corner of the triangle, wherein each of the hoisting line assemblies extends from the crane lug to one of the two upper beam lugs. Each hoisting line assembly may be made from one cable, a chain, or a sling or multiple parallel cables, chains, or slings. According to another further embodiment of the first aspect of the invention, the spreader beam according to the invention may comprise such a hoisting triangle/triangular rigging, comprising two hoisting lines assemblies, a crane lug defining a top corner of the triangle, and two upper beam lugs mounted on the beam and each defining a lower corner of the triangle, wherein each of the hoisting line assemblies extends from the crane lug to one of the two upper beam lugs.

C15: According to another further embodiment, separate from or in addition to previous further embodiments, the spreader beam may, according to the first aspect of the invention, further comprise:
a sensor system configured to measure at least heave, roll, and/or pitch of:
   a crane,
and/or
   the spreader beam,
and/or
   a platform, which carries the load to be hoisted or receives the hoisted load, and configured to generate a sensor signal representative for the measured heave, roll, and/or pitch; and
a controller configured to receive the sensor signal and operatively connected to the first and second actuator system to transfer control signals to the first respectively second actuator system;
the controller being configured to generate the control signals in response to the sensor signals to compensate the spreader beam or lifted load for heave, roll, and/or pitch of the platform.

In case of a sensor system configured to measure at least heave, roll, and/or pitch of the crane, there may be provided a suitable crane sensor on the crane or on the vessel on which the crane is located. Depending on the compensation algorithm used by the controller, the crane sensor may also usefully measure other degrees of freedom of the crane, such as the surge and/or the sway and/or the yaw of the crane.

In case of a sensor system configured to measure at least heave, roll, and/or pitch of the spreader beam, there may be provided a suitable beam sensor on the spreader beam. Depending on the compensation algorithm used by the controller, the beam sensor may also usefully measure other degrees of freedom of the beam, such as the surge and/or the sway and/or the yaw of the beam frame.

In case of a sensor system configured to measure at least heave, roll, and/or pitch of the platform, there may be provided a suitable platform sensor on the platform, which carries the load or will receive the load. Depending on the compensation algorithm used by the controller, the platform sensor may also usefully measure other degrees of freedom of the platform, such as the surge and/or the sway and/or the yaw of the platform.

In case there is a beam sensor provided on the spreader beam and a platform sensor on the platform, the controller may be configured to actively control the beam frame relative to the platform such that beam follows the movement of the platform to allow a soft landing of the beam or its slings onto the platform or onto the load.

C16-17: According to another further embodiment, separate from or in addition to previous further embodiments, the spreader beam may, according to the first aspect of the invention, further comprises two or more tugger lugs to allow the horizontal position of the spreader beam being manipulated by tugger lines-also called tag lines-attached to the tugger lugs. According to a further embodiment of this embodiment, the spreader beam may further comprise a tugger system comprising the tugger lines and winches, wherein the winches act:
passively via a spring or damper (exerting a passive force) on the tugger lines or
actively via an actuator controlled by a controller in response to one or more sensors, such as the beam sensor.

Such tugger system assist in the horizontal control of the spreader beam. Movement of the spreader beam in the horizontal plane (due to surge and/or sway) and/or around a vertical (yaw) to the spreader beam may be controlled with such a tugger system.

C18-19: According to a second aspect, the invention relates to the use of a spreader beam according to the first aspect of the invention for lifting a monopile or other long object. According to a further embodiment of this use, the weight of the monopile or other object being more than 500 tons, such as more than 1000 tons, more than 1500 tons, or more than 2000 tons.

C20: According to a third aspect, the invention relates to a crane provided with a spreader beam according to the first aspect of the invention.

C21: According to a fourth aspect, the invention relates to a vessel comprising a crane with a spreader beam according to the first aspect of the invention.

### BRIEF DESCRIPTION OF THE DRAWING

The invention will be explained further with reference to the drawings. In these drawings:

FIG. 1 shows in perspective and schematically a vessel having a crane provided with a spreader beam according to the invention.

FIG. 2 shows schematically a first embodiment of a spreader beam according to the invention.

FIG. 3 shows schematically a second embodiment of a spreader beam according to the invention.

FIG. 4A shows schematically a spreader beam according to the invention in a condition ready for coupling to a monopile to be lifted.

FIG. 4B shows schematically a spreader beam according to the invention in a condition coupled to a monopile to be lifted.

FIG. 5A shows schematically a spreader beam according to the invention in a condition of gradually tensioning to prepare for lifting.

FIG. 5B shows schematically a spreader beam according to the invention in a condition of starting lifting.

FIG. 6A shows schematically a spreader beam according to the invention in a condition ready for quick lifting.

FIG. 6B shows schematically a spreader beam according to the invention in a condition just after quick lifting.

FIG. 7 shows schematically a hydraulic scheme for a spreader beam according to the invention.

FIG. 8 shows schematically an enlarged illustration of quadrangular linkage mechanism of a spreader beam according to a third embodiment of the invention.

FIG. 9 shows schematically the second end of a spreader beam according to a third embodiment of the invention, in which third embodiment each mechanical linkage consists of a single link bar.

FIG. 10 shows schematically a fourth embodiment of a spreader beam according to the invention, which fourth embodiment shows a further variant of a mechanical linkage consisting of a single link bar.

### DETAILED DESCRIPTION OF THE EMBODIMENTS

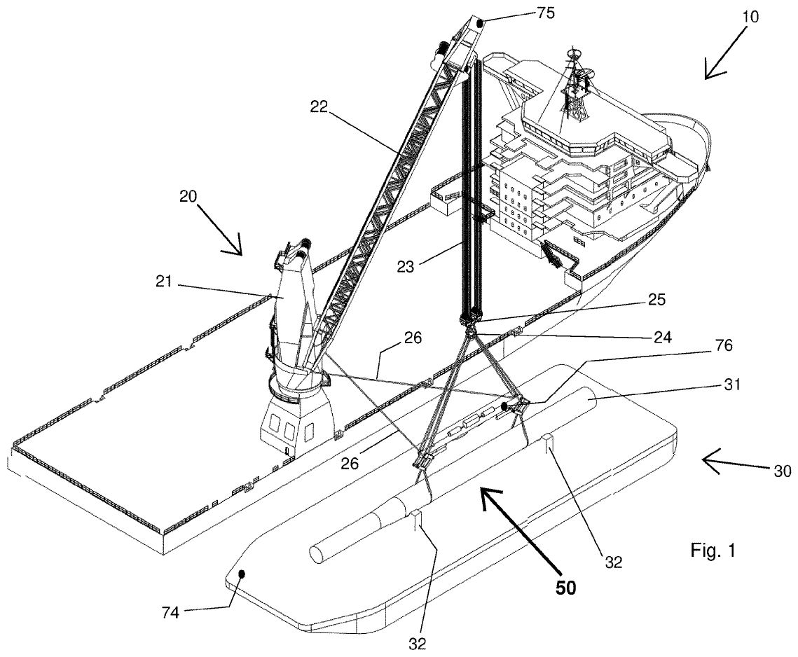

FIGS. 1-10 illustrate the invention with reference to several embodiments which might differ from each other. However, for similar parts same reference numbers have been used regardless of the embodiment, in other words an item x in relation to an embodiment y is similar to an item x in relation to embodiment z.

FIG. 1 shows a vessel 10 according to the invention having a crane 20 according to the invention provided with a spreader beam 50 according to the invention. The crane 20 is provided on deck of the vessel 10 and comprises a tower 21 and boom 22. The crane further comprises a hoisting cable assembly 23, which assembly 23 may according to this example comprise two bundles of multiple hoisting cables. A crane hook 24—in this application also called crane lug—is provided at the lower end of the hoisting cable assembly. The vessel 10 may be a any floating object subjected to amongst others heave, roll, and/or pitch due to water movement, but vessel 10 may also be a jack up barge, which when jacked up is supported on the bottom of the sea and not susceptible to heave, roll, and pitch movements. It is also conceivable that instead of being located on a vessel, the crane may also be a land based crane or a crane located on a platform fixed relative to the world, for example an oil and/or gas platform.

FIG. 1 further shows a barge 30 having a deck provided with supports 32 on which a monopile 31 for a wind turbine is arranged, which monopile 31 is supported by two supports 32.

FIG. 1 further shows a spreader beam 50 according to the invention.

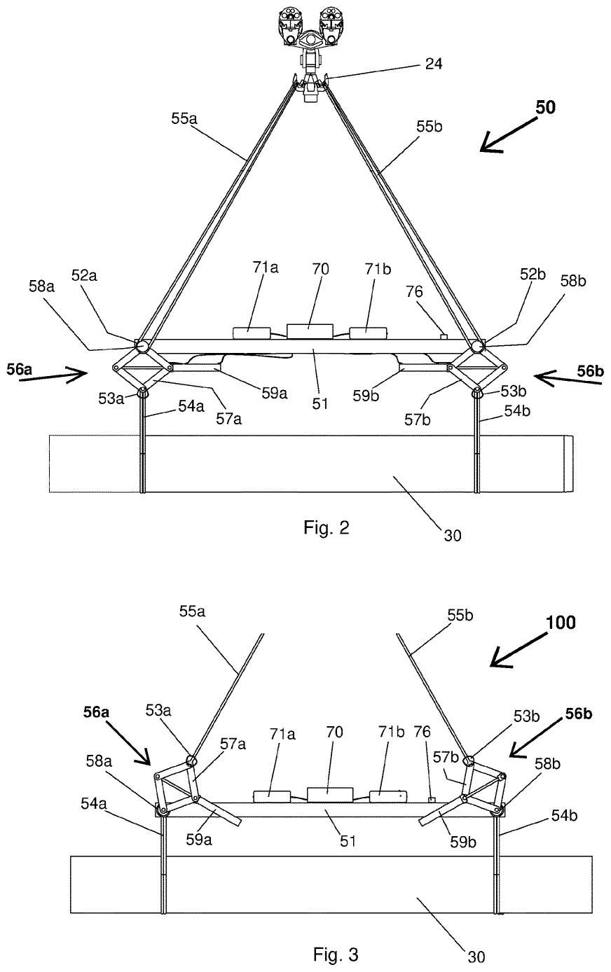

The spreader beam 50 of FIG. 1 is shown in more detail in FIG. 2.

Referring to FIG. 2, the spreader beam 50 according to the invention comprises a beam frame 51 extending from a first end 51 to a second end 52. The spreader beam 50 comprises, at the first end 52a of the beam frame 51, a first lug 53a for attachment to a first elongate hoisting assembly 54a, in this example a so called sling. The spreader beam 50 further comprises, at the second end 52b of the beam frame 51, a second lug 53b for attachment to a second elongate hoisting assembly 54b, in this example a so called sling.

With a view onto offshore use, the spreader beam 50 according to the invention is provided with a first adjustment mechanism 56a configured for adjusting the position of the first lug 53a relative to the beam frame 51, and is further provided with a second adjustment mechanism 56b configured for adjusting the position of the second lug 53b relative to the beam frame 51.

Each of the adjustment mechanisms 56a, 56b comprises according to the invention a mechanical linkage mechanism 57 (in the preceding text called in short ‘mechanical linkage’): a first mechanical linkage mechanism 57a associated to the first adjustment mechanism 56a and arranged at the first end 52a of the beam frame 51, and a second mechanical linkage mechanism 57b associated to the second adjustment mechanism 56b and arranged at the second end 52b of the beam frame 51. Each adjustment mechanism 56 further comprises an actuator system 59: a first actuator system 59a associated to the first adjustment mechanism 56a and a second actuator system 59b associated to the second adjustment mechanism 56b. The first lug 53a is mounted to the first mechanical linkage mechanism, and the second lug 53b is mounted to the second mechanical linkage mechanism. The first mechanical linkage mechanism 57a is mounted by a first hinged joint 58a to the beam frame 51, and the second mechanical linkage mechanism 57b is mounted by a second hinged joint 58b to the beam frame 51. The first actuator system 59a is configured to act on the first mechanical linkage mechanism 57a such that it can move the first lug 53a relative to the beam frame 51, and the second actuator system 59b is configured to act on the second mechanical linkage mechanism 57b such that it can move the first lug 53b relative to the beam frame 51.

As can be seen in FIG. 2, the first adjustment mechanism 57a is operative independent from the second adjustment mechanism 57b, and vice versa the second adjustment mechanism 57b is operative independent from the first adjustment mechanism 57a.

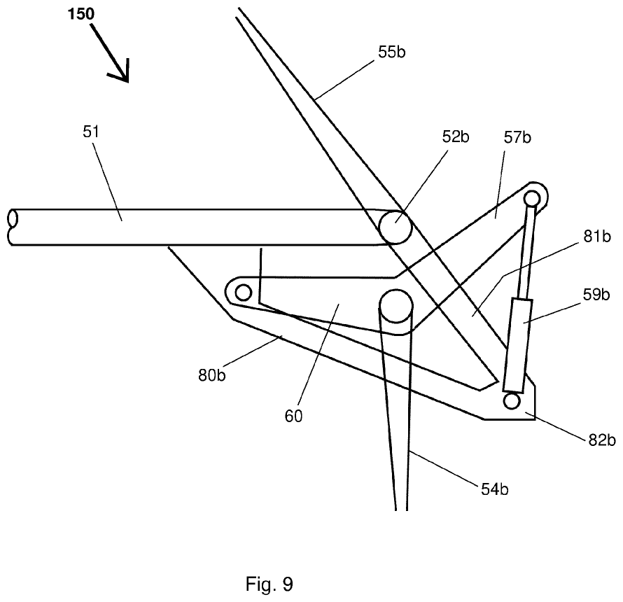

Referring to the enlarged view of FIG. 8, the first linkage mechanism comprises four link bars 61, 62, 63 and 64, which bars are connected by hinges 65, 66, 67, and 68 to define a quadrangular linkage mechanism, which is in the shown embodiments a parallelogram construction. Similarly, also the second linkage mechanism comprises four link bars 61, 62, 63 and 64, which bars are connected by hinges 65, 66, 67, and 68 to define a quadrangular linkage mechanism, which is in the shown embodiments a parallelogram construction.

As indicated in FIG. 8 by a double arrow P, the actuator systems have a principal direction of operation. The actuator systems 59 shown are hydraulic actuators, but also electric actuators or other type of actuators are conceivable.

As shown in the embodiment of FIG. 2, the first and second linkage mechanisms 57a and 57b may be provided at the lower side of the beam frame 51 to be operative between the beam frame and the load to be lifted. In this case the first elongate hoisting assembly and the second elongate hoisting assembly will be the sling 54a respectively the sling 54b to be attached to the load (monopile) to be lifted. It is however also possible, see the second embodiment 100 of the spreader beam in FIG. 3, that the first and second linkage mechanisms 57a and 57b may be provided at the upper side of the beam frame 51 to be operative between the beam frame and crane. In this case the first elongate hoisting assembly and the second elongate hoisting assembly will be the slanting chain/cable 55a respectively the slanting chain/cable 55b attached to crane hook 25 (not shown in FIG. 3). Otherwise, in this example, the spreader beam 50 of FIG. 2 and the spreader beam 100 of FIG. 3 are essentially the same.

As can be seen in both FIG. 2 and FIG. 3, the first and second actuator system are arranged transverse to the elongate hoisting assembly attached to the lug of the associated mechanical linkage mechanism.

Referring to FIGS. 2 and 3, the actuator systems are in these exemplary embodiments hydraulic actuator systems and the spreader beam comprises a hydraulic power unit 70 for the pressurized hydraulic medium to operate the actuator systems. I addition, the spreader beam may according to the invention also be provided with a first accumulator 71a associated to the first actuator system 59a and a second accumulator 71b associated to the second actuator system 59b. These accumulators may be used for:
providing the respective hydraulic actuator systems with a spring functionality, and/or
providing the respective hydraulic actuator systems with a so called ‘quick lifting’ functionality.

The spring functionality allows the actuator systems to be used as passive heave compensators, compensating for heave, roll and/or pitch motions of the platform which carries the load to be lifted or which is going to receive a lifted load. The quick lifting functionality allows the load to be lifted quickly from the platform carrying the load to be lifted. Quickly lifting in offshore use prevents the platform or objects of the platform from hitting the load when just lifted from the platform.

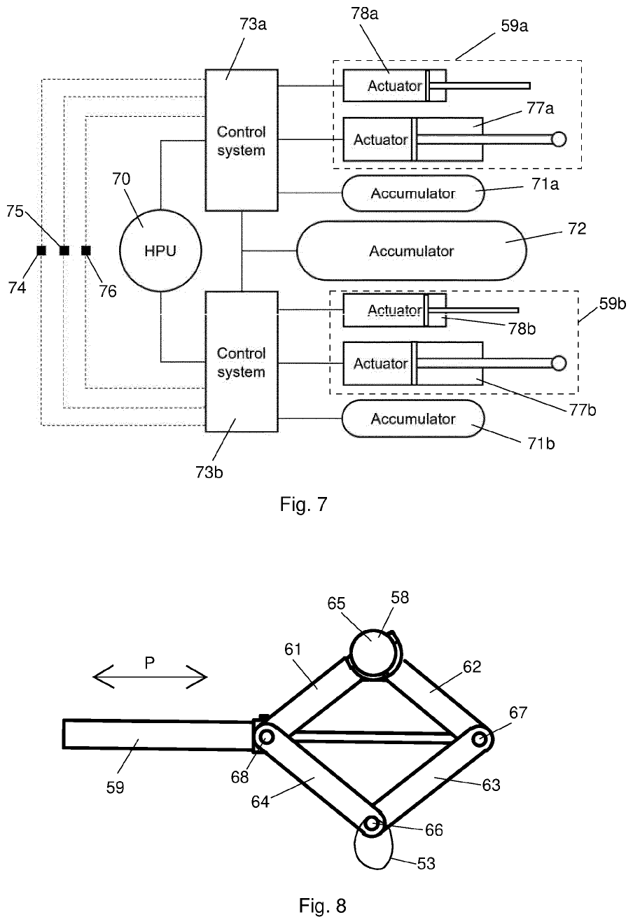

FIG. 7 shows schematically the hydraulic layout of a spreader beam according to the invention.

FIG. 7 shows the first actuator system 59a being powered by a hydraulic power unit 70 and controlled by a first controller 73a. The second actuator system 59b is powered by the same hydraulic power unit 70 and controlled by a second controller 73b. Although in FIG. 7 there is one single hydraulic power unit for both the actuator systems, it is also conceivable to provide each actuator system with its own hydraulic power unit. In case the compensation is only passive compensation, the hydraulic power unit may be dispensed with.

Although FIGS. 2 and 3 show the hydraulic power unit 70 as provided on the beam frame 51, it is also conceivable to locate the hydraulic power unit on the crane or on the platform carrying the load or to receive the load. The hydraulic power unit may then be connected to the actuator systems on the spreader beam by means of hydraulic hoses. The same applies for the accumulator(s) 71, 71a, 71b. Also these are shown in FIGS. 1 and 2 as provided on the beam frame 51, but may also be located on the crane or on the platform carrying the load or to receive the load.

In case the spreader beam is to be compensated for heave and/or roll and/or pitch movements of the crane, and/or the beam frame, and/or the platform for carrying or receiving the load, each controller may control its associated actuator system for passive compensation and/or active compensation. In case of passive compensation, the controller may control a valve, like a shut-off valve, in a connection between its associated accumulator and its associated hydraulic actuator system to control enabling and disabling of the spring action (effected by the accumulator) In case of active compensation, the controller will receive input from a first sensor 74 and/or from a second sensor 75 and/or third sensor 76.

The first sensor 74 is—see also FIG. 1—provided on the platform carrying or receiving the load, and provides motion information of the platform carrying or receiving the load. This motion information may contain measurements of the heave and/or roll and/or pitch of the platform. The controller will then use these measurements to generate control signals to control the actuator system for counteracting these measured movements. In case the platform is the deck of a jack-up barge or any other platform not subjected to water movement, then this first sensor 74 may not be required.

The second sensor 75 is—see also FIG. 1—provided on the crane, and provides motion information of the crane. This motion information may contain measurements of the heave and/or roll and/or pitch of the crane. The controller will then use these measurements to generate control signals to control the actuator system for counteracting these measured movements. In case the crane is located on jack-up barge or any other platform not subjected to water movement, then this second sensor 74 may not be required.

The third sensor 76 is—see also FIGS. 1, 2 3—provided on the beam frame 51 of the spreader beam 50, and provides motion information of the beam frame. This motion information may contain measurements of the heave and/or roll and/or pitch of the beam frame, as well as measurements of the surge and/or sway and/or yaw of the beam. The controller will then use these measurements to generate control signals to control the actuator system for counteracting these measured movements. In case the crane is located on jack-up barge or any other platform not subjected to water movement, then this third sensor 74 may not be required.

The first and second sensor may also be absent in case of only passive compensation.

The third accumulator 72 is via the controller 73a connectable with the first actuator system 59a and via the controller 73b with the second actuator system 59b. The accumulator 72 may be loaded with gas under high pressure, which, when released by the respective controllers to subject the associated actuator systems to this high pressure, forces the actuator systems to quickly extend in order to quickly lift the load over a distance of at least 2 decimeters (=20 cm), such as over a distance of at least 5 decimeters (=50 cm) or more.

As shown in FIG. 7, the first actuator system 59a may comprise a (first) passive actuator 77a, such as a hydraulic actuator, for carrying the weight of the load, and a (first) actively controlled actuator 78a. The actively controlled actuator 78a may for example be an hydraulic actuator, an electric actuator, or any other type of actuator. The same applies for the second actuator system 59b. As shown in FIG. 7, the second actuator system 59b may comprise a (second) passive actuator 77b, such as a hydraulic actuator, for carrying the weight of the load, and a (second) actively controlled actuator 78b. The actively controlled actuator 78b may for example be an hydraulic actuator, an electric actuator, or any other type of actuator.

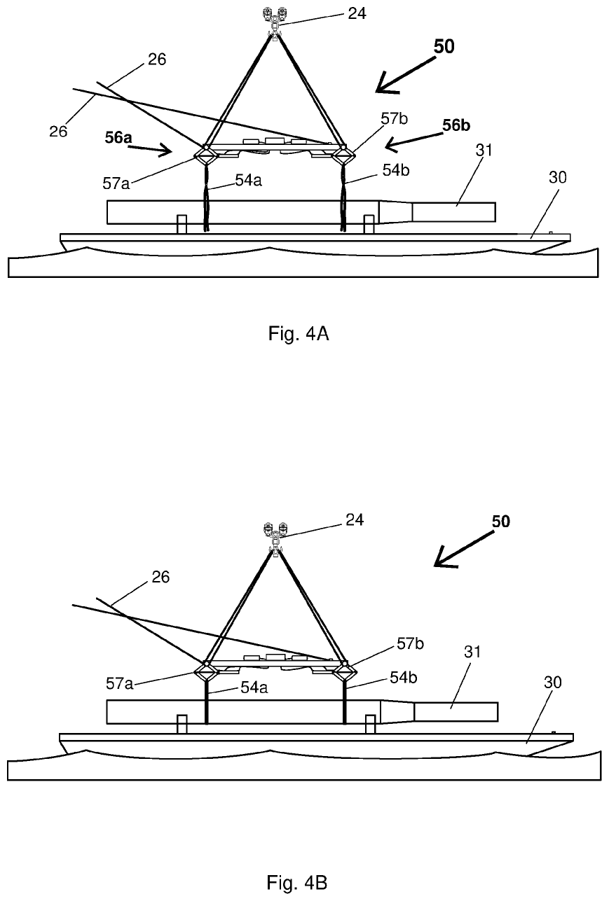

FIGS. 4-6 show several examples of operative conditions of the spreader beam according to the invention. In addition to the spreader beam, also tugger lines 26 are shown by means of which the horizontal position of the spreader beam may be manipulated.

In FIG. 4A the slings 54a and 54b hang loosely around the monopile and are ready for being connected to the monopile. As such motion compensation in this stage may not be necessary when the slings have a sufficient excess of length to allow coupling to the monopile subjected to heave, roll, and/or pitch movement. In case the slings do not have a sufficient excess of length, then active motion compensation to keep the slings motionless with respect to the monopile may be helpful.

In FIG. 4B the slings 54a and 54b are connected to the monopile and the lifting operation to lift the monopile may be initiated.

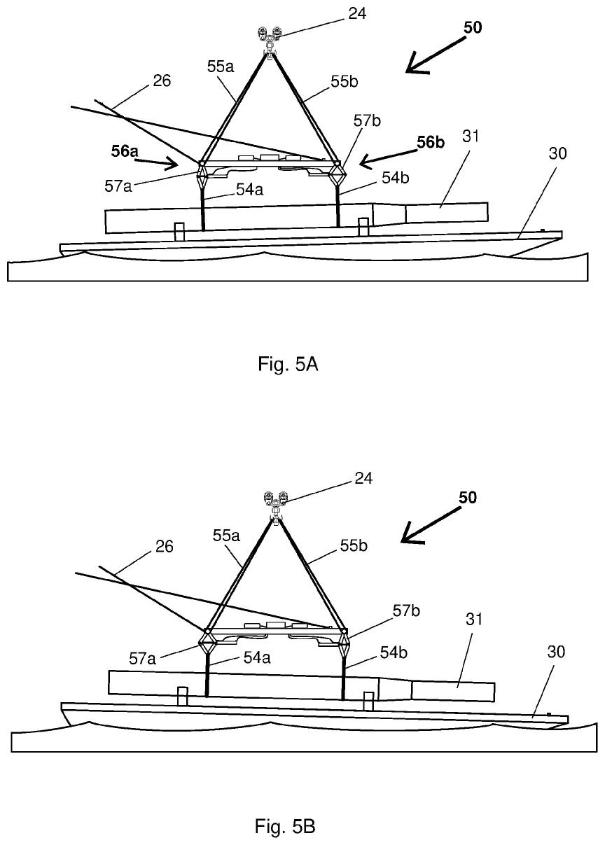

FIG. 5A shows a phase in the initiation of the lifting operation, which may follow on the condition of FIG. 4B. In this phase, the slings 54a, 54b, the hoisting members 55a, 55b forming the hoisting triangle/triangular rigging, and the hoisting cable assembly 23 (FIG. 1), are gradually tensioned up to a load corresponding to substantial part of the weight of the load to be lifted. As shown in FIG. 5A, the mechanical linkage mechanisms 57a and 57b may, during this phase of gradually tensioning, be used for passive and/or active compensation of heave, roll, and/or pitch of the barge 30.

FIG. 5B shows the start of the actual lifting of the monopile. During this phase of starting the actual lifting, the passive and or active compensation of heave, roll, and/or pitch may be continued up to the monopile (or other load) has been lifted sufficiently above the platform (of the barge 30).

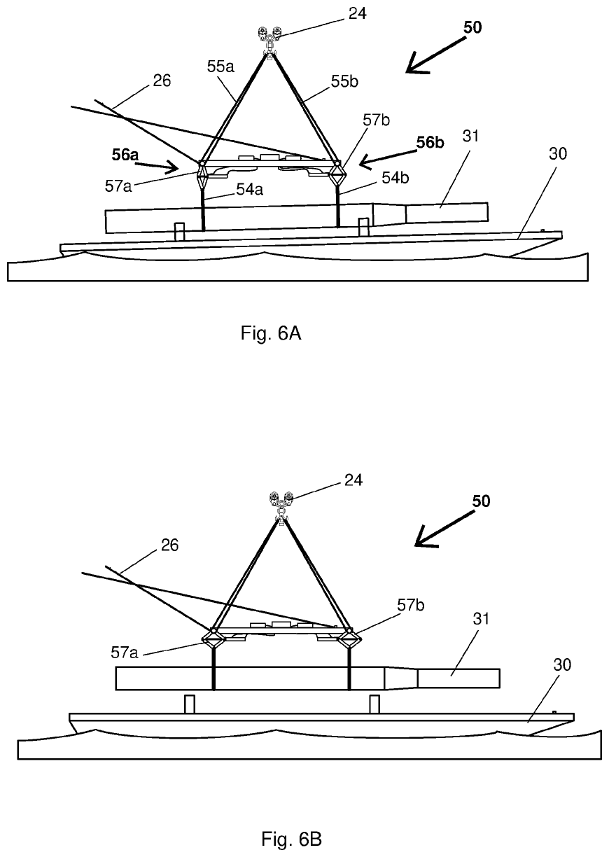

FIG. 6 illustrates another manner of initiating the lifting operation by means of the quick lift functionality. First the slings 54a, 54b, the hoisting members 55a, 55b forming the hoisting triangle/triangular rigging, and the hoisting cable assembly 23 (FIG. 1), are gradually tensioned up to a load corresponding to a substantial part of the weight of the load to be lifted. The mechanical linkage mechanisms 57a and 57b may, during this phase of gradually tensioning, be used for passive and/or active compensation of heave, roll, and/or pitch of the barge 30 The pressure of the accumulator 72 is released by the controllers and the monopile or other object to be lifted is quickly raised by expanding the actuator systems which in turn shortens the vertical height of the mechanical linkage mechanisms while increasing the horizontal width of the mechanical linkage mechanisms.

FIG. 9 shows schematically the second end of a spreader beam according to a third embodiment 150 of the invention. The first end of this spreader beam 150 is mirror symmetrical with respect to the second end, the mirror being arranged vertically transverse to the sheet of paper. In this embodiment, the mechanical linkage mechanism 57b comprises one single V-shaped link 60, the V-shape being an obtuse V-shape. The beam frame 51 is in this example extended with a V-shaped support frame having an arm 80b and an arm 81b, which are rigidly connected with each other at the tip 82b of the V. The actuator mechanism 59b is hingedly connected to the tip 82b of the V-shaped support frame and also hingedly connected to the free end of the V-shaped link 80b. The other end of the V-shaped link 80b is hingedly connected to the beam frame 51 or V-shaped support frame 80v, 81b. One side 55b of the rig triangle is attached to the second end 52 of the beam frame 51. The load (to be lifted) is carried by the sling 54b. Here the single link provides a lever. It is noted that the support frame 80b, 81b may be absent or differently shaped, and that also the link 80b may have some different shape.

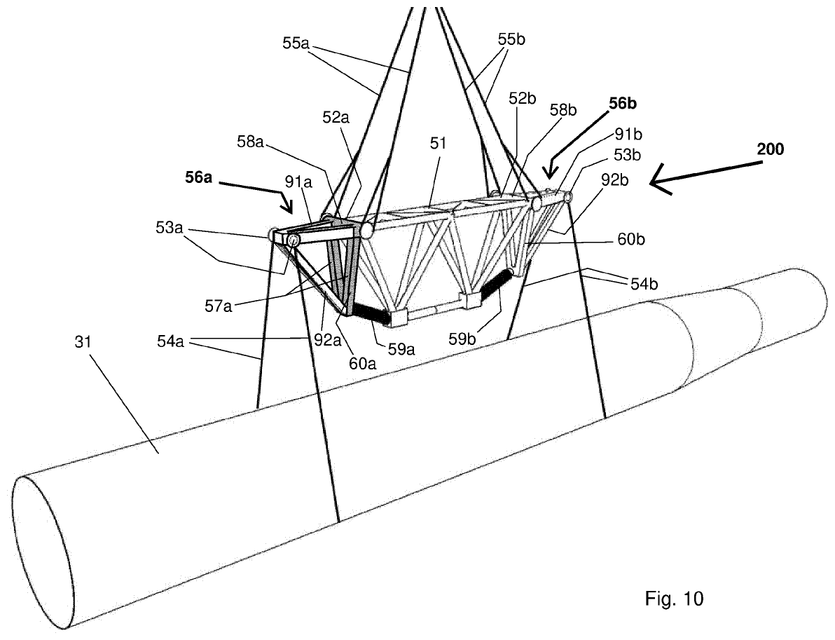

FIG. 10 shows schematically a spreader beam according to a fourth embodiment 200 of the invention. Similar to the third embodiment 150 illustrated by means of FIG. 9, the mechanical linkage mechanisms 57a and 57b consist of one single link 60a respectively 60b. For clarity of illustration, the single link 60a has been coloured grey, but it will be understood that this grey colour does not make this single link 60a different from the single link 60b.

Also in FIG. 10 the single links 60a and 60b are shown as V-shaped, but an acute angle instead of an obtuse angle as in FIG. 9. In FIG. 10 the V-shape of the single link bar is not material. The shape of the single link bar 60a, 60b may be any other shape as well.

In the example of FIG. 10 the single link bars 60a and 60b are so to say straight and vertical. In the example of FIG. 10, the upper ends of the single link bars 60a and 60b are mounted by a first hinged joint 58a respectively a second hinged joint 58b to the first respectively second end of the beam frame 51. In the example of FIG. 10, the first actuator 59a and second actuator 59b engage on the lower end of the first single link bar 60a respectively the second single link bar 60b.

In the example of FIG. 10, the first lug 53a and second lug 53b are provided on the first single link bar 60a respectively the second single link bar 60b by means of a first triangular support frame 91a, 92a respectively a second triangular support frame 91b, 92b.

### LIST OF REFERENCES USED IN THE FIGURES

10 vessel
20 crane
21 tower
22 boom
23 hoisting cable assembly
24 crane hook
26 tugger line
30 barge
31 monopile
32 monopile support
50 spreader beam according to a first embodiment
51 beam frame
52a first end
52b second end
53a first lug
53b second lug
54a first load hoisting assembly
54b second load hoisting assembly
55a first crane hoisting assembly
55b second crane hoisting assembly
56a first adjustment mechanism
56b second adjustment mechanism
57 first mechanical linkage mechanism
57b second mechanical linkage mechanism
58a first hinged joint
58b second hinged joint
59a first actuator system
59b second actuator system
60 single link
61 first link bar
62 second link bar
63 third link bar
64 fourth link bar
65 first hinge
66 second hinge
67 third hinge
68 fourth hinge
70 hydraulic power unit
71a first accumulator
71b second accumulator
72 quick lift accumulator
73a first controller
73b second controller
74 sensor
75 sensor
76 sensor
77a first passive actuator (of first actuator system)
77b second passive actuator (of second actuator system)
78a first active actuator (of first actuator system)
79b second active actuator (of second actuator system)
80 arm of V-shaped support
81 arm of V-shaped support
82 tip of V-shaped support
91 first support member
92 second support member
P principal direction of operation
100 spreader beam according to a second embodiment
150 spreader beam according to a third embodiment
200 spreader beam according to a fourth embodiment

1. A spreader beam for distributing a lifting force of a hoisting crane over a load to be lifted, the spreader beam extending from a first end to a second end, wherein the spreader beam comprises:
at the first end, a first lug for attachment to a first elongate hoisting assembly, such as a cable, a chain, a sling or a multiple of cables, chains or slings,
at the second end, a second lug for attachment to a second elongate hoisting assembly, such as a cable, a chain, a sling or a multiple of cables, chains or slings,
a first adjustment mechanism configured for adjusting the position of the first lug relative to the spreader beam, and
a second adjustment mechanism configured for adjusting the position of the second lug;
wherein the first adjustment mechanism comprises:
a first mechanical linkage mechanism arranged at the first end of the spreader beam, and
a first actuator system,
the first lug being mounted to the first mechanical linkage mechanism, the first mechanical linkage mechanism being mounted to the spreader beam by a (first) hinged joint, and the first actuator system being configured to act on the first mechanical linkage mechanism for moving the first lug relative to the spreader beam;
wherein the second adjustment mechanism comprises:
a second mechanical linkage mechanism arranged at the second end of the spreader beam, and
a second actuator system,
the second lug being mounted to the second mechanical linkage mechanism, the second mechanical linkage mechanism being mounted to the spreader beam by a (second) hinged joint, and the second actuator system being configured to act on the second mechanical linkage mechanism for moving the second lug relative to the spreader beam; and
wherein the first and second adjustment mechanism are configured to be operative independently from each other.

2. The spreader beam according to claim 1,
wherein the first and second mechanical linkage mechanism each comprise four link bars connected by hinges defining a quadrangular linkage mechanism,
wherein a first one of the hinges defines the first respectively second hinged joint mounting the respective mechanical linkage mechanism to the spreader beam,
wherein the lug associated to the respective mechanical linkage mechanism is provided at a second one of the hinges opposite the first hinge, and
wherein the actuator system associated to the respective linkage mechanism is arranged (mounted) on the linkage mechanism so as to move two opposite pivot points of the linkage mechanism relative to each other.

3. The spreader beam according to claim 2, wherein the quadrangular linkage mechanism is a parallelogram construction of the four said link bars.

4. The spreader beam according to claim 1, wherein the first and second actuator system each have a principal direction of operation, which principal direction is transverse to the elongate hoisting assembly (to be) attached to the first respectively second lug.

5. The spreader beam according to claim 1, wherein the first and second actuator system each comprise a hydraulic actuator system.

6. The spreader beam according to claim 5, wherein the spreader beam further comprises an accumulator system with a pressurized gas and configured to be connectable with the first and second hydraulic actuator systems; preferably wherein the accumulator system comprises a first accumulator configured to be connectable with the first hydraulic actuator system, and a second accumulator configured to be connectable with the second hydraulic actuator system, the first and second accumulator being configured to be operative independently from each other.

7. (canceled)

8. The spreader beam according to claim 6, wherein the accumulator system is configured to act as a spring for each of the hydraulic actuator systems.

9. The spreader beam according claim 6, wherein in the spreader beam further comprises a controller, and wherein the controller, the first actuator system, and the second actuator system are configured to extend the first and second actuator system, within a timeframe of about halve the wave period of the water, over a distance of at least 2 to 3 decimeters, such as over a distance of at least 2 to 7 decimeters or over a distance in the range of 0.5 to 1 meter.

10. The spreader beam according to claim 9, wherein the valve is provided between the accumulator system and each of the hydraulic actuator systems, and wherein the accumulator system, controller, and valve are configured to extend the hydraulic actuator systems, within a timeframe of about halve the wave period of the water, over a distance of at least 2 to 3 decimeters, such as over a distance of at least 2 to 7 decimeters or over a distance in the range of 0.5 to 1 meter, once the valve is opened by the controller.

11. The spreader beam according to claim 1, wherein the first lug and the second lug are configured for attachment to a first respectively second hoisting assembly extending between the spreader beam and the load to be lifted.

12. The spreader beam according to claim 1, wherein the first lug and the second lug are configured for attachment to a first respectively second hoisting assembly extending between the spreader beam and the hoisting crane.

13. The spreader beam according to claim 1, wherein the spreader beam is configured to be carried by a hoisting triangle (or triangular rigging) having an upper corner for attachment to a crane hook, a first lower corner for attachment to the first end of the spreader beam, and a second lower corner for attachment to the second end of the spreader beam so that a lifting force exerted by the crane hook introduces compressive forces in the spreader beam.

14. The spreader beam according to claim 1, further comprising a hoisting triangle (or triangular rigging), the hoisting triangle (or triangular rigging) comprising two hoisting line assemblies, a crane lug defining a top corner, and two upper beam lugs mounted on the beam and each defining a lower corner of the triangle, wherein each of the hoisting line assemblies extends from the crane lug to one of the two upper beam lugs.

15. The spreader beam according to claim 1, wherein the spreader beam further comprises:
a sensor system configured to measure at least heave, roll, and/or pitch of:
a crane, and/or
the spreader beam, and/or
a platform, which carries the load to be hoisted or receives the hoisted load,
and configured to generate a sensor signal representative for the measured heave, roll, and/or pitch; and
a controller configured to receive the sensor signal and operatively connected to the first and second actuator system to transfer control signals to the first respectively second actuator system;
the controller being configured to generate the control signals in response to the sensor signals to compensate the spreader beam or the lifted load for heave, roll, and/or pitch of the platform.

16. The spreader beam according to claim 1, wherein the spreader beam further comprises two or more tugger lugs to allow the horizontal position of the spreader beam being manipulated by tugger lines attached to the tugger lugs.

17. The spreader beam according to claim 16, such wherein the spreader beam further comprise a tugger system comprising winches and the tugger lines,
wherein the winches act:
passively as a spring or damper system on the tugger lines or
actively via an actuator controlled by a controller in response to one or more sensors, such as the beam sensor.

18. A use of a spreader beam according to claim 1, for lifting a monopile or other long object.

19. The use according to claim 18, wherein the weight of the monopile or other object being more than 500 tons, such as more than 1000 tons, more than 1500 tons, or more than 2000 tons.

20. A crane provided with a spreader beam according to claim 1.

21. A vessel comprising a crane with a spreader beam according to claim 1.
